(19) United States
(12) Patent Application Publication
(10) Pub. No.: US 2026/0057493 A1
(43) Pub. Date: Feb. 26, 2026

(54) IMAGE STABILIZATION METHOD AND IMAGE PROCESSING DEVICE

(71) Applicant: HANWHA VISION CO., LTD., Seongnam-si (KR)

(72) Inventor: Gab Cheon JUNG, Seongnam-si (KR)

(73) Assignee: HANWHA VISION CO., LTD., Seongnam-si (KR)

(21) Appl. No.: 18/984,285

(22) Filed: Dec. 17, 2024

(30) Foreign Application Priority Data
Aug. 22, 2024 (KR) 10-2024-0113105

(51) Int. Cl. G06T 5/73; G06T 7/246

(52) U.S. Cl. CPC G06T 5/73; G06T 7/248

(57) ABSTRACT

An image stabilization method includes: determining a representative value of one or more unit areas constituting an input frame; determining a type of the one or more unit areas based on at least one classification model and the representative value of each of the one or more unit areas, respectively; extracting at least one valid feature point within the input frame based on the type of the one or more unit areas; generating motion data of the input frame based on an inter-frame motion of the at least one valid feature point; and correcting the input frame based on the motion data of the input frame.

### CROSS-REFERENCE TO RELATED APPLICATION

This application is based on and claims priority to Korean Patent Application No. 10-2024-0113105, filed on Aug. 22, 2024, in the Korean Intellectual Property Office, the disclosure of which is incorporated by reference herein in its entirety.

### BACKGROUND

### 1. Field

The disclosure relates to an image stabilization method and an image processing device for preventing a shaking correction error due to a large dynamic object.

### 2. Description of Related Art

With the development of optical technology, surveillance cameras and others are supporting ultra-high magnification zoom of 40 times or more. In ultra-high magnification, a lot of movement occurs in an image even with the fine shaking of a camera, and in such a fine shaking situation, it is difficult to correct the shaking using a gyro sensor, and thus, an image-based stabilization method may be used.

Image stabilization (based on images) may cause a malfunction of judging, as global movements, large dynamic objects or multi-object movements move in the same direction in images.

Image-based shaking correction is performed based on a local motion vector (LMV), which requires a large amount of computations when extracting an LMV, and accordingly, there is a clear limitation that only a limited number of LMVs are used in the real-time system. In addition, the use of a limited number of LMVs has the problem that some of the LMVs contain motions such as dynamic objects in the image rather than camera shake, which ultimately reduces the accuracy of calculating the global motion vector (GMV) calculated with the LMVs, thereby lowering the quality of the correction.

### SUMMARY

Provided are an image stabilization method and an image processing device to accurately correct the shaking of an input image even when a dynamic object appears.

In addition, provided are an image stabilization method and an image processing device to improve the accuracy of input image correction by dynamically adjusting the size of unit areas used and the number of unit areas used in determining the motion characteristics of an input image.

In addition, provided are an image stabilization method and an image processing device to minimize malfunction by adjusting, based on the degree of motion of an input image, the range of a model used to classify unit areas into background types.

Additional aspects will be set forth in part in the description which follows and, in part, will be apparent from the description, or may be learned by practice of the presented embodiments of the disclosure.

According to an aspect of the disclosure, an image stabilization method may include: determining a representative value of one or more unit areas constituting an input frame; determining a type of the one or more unit areas based on at least one classification model and the representative value of each of the one or more unit areas, respectively; extracting at least one valid feature point within the input frame based on the type of the one or more unit areas; generating motion data of the input frame based on an inter-frame motion of the at least one valid feature point; and correcting the input frame based on the motion data of the input frame.

The image stabilization method may further include determining a size of the one or more unit areas based on a noise level of the input frame before determining the representative value of the one or more unit areas.

The determining the size of the one or more unit areas may include: based on an increase in the noise level of the input frame, increasing the size of the one or more unit areas to reduce a quantity of the one or more unit areas constituting the input frame, and based on a decrease in the noise level of the input frame, decreasing the size of the one or more unit areas to increase the quantity of the one or more unit areas constituting the input frame.

The determining the type of the one or more unit areas may include determining the type based on whether each representative value of the one or more unit areas is within a range according to the at least one classification model.

The image stabilization method may further include adjusting the range according to the at least one classification model based on the motion data of the input frame.

The at least one classification model may include a background model to determine whether one or more unit areas correspond to a background area, where the adjusting of the range includes: generating reference motion data based on the motion data of the input frame, and adjusting the range according to the background model based on the reference motion data.

The adjusting the range may include: expanding the range of the background model based on an increase in movement of the input frame based on the reference motion data; and reducing the range of the background model based on a decrease in the movement of the input frame based on the reference motion data.

The at least one classification model may include: a background model to determine whether one or more unit areas correspond to a background area; a foreground model to determine whether one or more unit areas correspond to a foreground area; and a short-term motion model to determine whether one or more unit areas correspond to a motion area that has motion.

The extracting the valid feature point may include: determining, as candidate valid feature points, feature points corresponding to an area determined as a background area among the one or more unit areas constituting the input frame; and extracting at least some of the candidate valid feature points based on a contrast of the valid feature point.

The generating the motion data of the input frame may include generating motion data based on a difference between a position in a frame preceding the input frame and a position in the input frame, with respect to at least one valid feature point corresponding to a background area of the input frame.

According to an aspect of the disclosure, an image processing device may include at least one memory storing instructions, and at least one processor configured to execute the instructions, where, by executing the instructions, the at least one processor is configured to: determine a representative value of one or more unit areas constituting an input frame; determine a type of the one or more unit areas based on at least one classification model and the representative value of the one or more unit areas, respectively; extract at least one valid feature point within the input frame based on the type of the one or more unit areas; generate motion data of the input frame based on an inter-frame motion of the at least one valid feature point; and correct the input frame based on the motion data of the input frame.

The at least one processor may be further configured to determine a size of the one or more unit areas based on a noise level of the input frame.

The at least one processor may be further configured to: based on an increase in the noise level of the input frame, increase the size of the one or more unit areas to reduce a quantity of the one or more unit areas constituting the input frame, and based on a decrease in the noise level of the input frame, decrease the size of the one or more unit areas to increase the quantity of the one or more unit areas constituting the input frame.

The at least one processor may be further configured to determine the type of the one or more unit areas based on whether a representative value of the one or more unit areas is within a range according to the at least one classification model.

The at least one processor may be further configured to adjust the range of the at least one classification model based on the motion data of the input frame.

The at least one classification model may include a background model configured to determine whether one or more unit areas correspond to a background area, where the at least one processor is further configured to: generate reference motion data based on the motion data of the input frame, and adjust the range according to the background model based on the reference motion data.

The at least one processor may be further configured to: expand the range of the background model based on an increase in movement of the input frame according to the reference motion data, and reduce the range of the background model based on a decrease in the movement of the input frame according to the reference motion data.

The at least one classification model may include: a background model configured to determine whether one or more unit areas correspond to a background area; a foreground model configured to determine whether one or more unit areas correspond to a foreground area; and a short-term motion model configured to determine whether one or more unit areas correspond to a motion area that has motion.

The at least one processor may be further configured to: determine, as candidate valid feature points, feature points corresponding to an area determined as a background area among the one or more unit areas constituting the input frame; and extract at least some of the candidate valid feature points based on a contrast of the valid feature point.

The at least one processor may be further configured to generate motion data of the input frame based on a difference between a position in a frame preceding the input frame and a position in the input frame, with respect to at least one valid feature point corresponding to a background area of the input frame.

According to an aspect of the disclosure, a non-transitory recording medium storing a computer program, which, when executed, may cause at least one processor to execute a method including: determining a representative value of a unit area included in an input frame; determining a type of the unit area based on at least one classification model and the representative value of the unit area; extracting at least one valid feature point within the input frame based on the type of the unit area; generating motion data of the input frame based on an inter-frame motion of the at least one valid feature point; and correcting the input frame based on the motion data of the input frame.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram schematically illustrating a surveillance camera system according to an embodiment;

FIG. 2 is a diagram schematically showing a configuration of a surveillance camera according to an embodiment;

FIG. 3 is a diagram to describe unit areas according to an embodiment;

FIG. 4 is a diagram illustrating a method in which a first processor determines the size of one or more unit areas according to an embodiment;

FIG. 5 is a diagram to explain a process in which the first processor determines a representative value according to an embodiment;

FIG. 6 is a graphical diagram to explain a classification model according to an embodiment;

FIG. 7 is a graphical diagram to describe a process in which the first processor adjusts a classification range according to the model according to an embodiment;

FIG. 8 is a diagram to explain a process of extracting at least one valid feature point in an input frame by the first processor according to an embodiment;

FIG. 9 is a diagram to describe a process in which the first processor generates motion data according to an embodiment; and

FIG. 10 is a flowchart illustrating an image stabilization method performed by the surveillance camera according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “or” includes any and all combinations of one or more of the associated listed items. Expressions such as “at least one of,” when preceding a list of elements, modify the entire list of elements and do not modify the individual elements of the list.

The disclosure may apply various transforms and have various embodiments, and particular embodiments are illustrated in the drawings and will be described in detail in the detailed description with reference to the illustrated drawings. The effects and features of the disclosure, and methods of achieving the effects and features, will become apparent with reference to the embodiments described in detail with reference to the drawings. However, the disclosure is not limited to the embodiments disclosed below, but may be implemented in various forms.

Hereinafter, embodiments of the disclosure will be described in detail with reference to the accompanying drawings, and the same or corresponding components will be denoted by the same reference numerals and redundant descriptions thereof will be omitted.

In the disclosure, terms such as first, second, and the like are used for the purpose of distinguishing one component from another component, and should not be construed to limit the corresponding component in other aspects (e.g., importance or order). In the disclosure, the expression of the singular includes the expression of the plural, unless the context clearly indicates otherwise. In the disclosure, terms such as “includes,” “comprises,” “has,” “having,” “including,” “comprising,” and the like mean that the features or components described in the disclosure exist, but do not preclude the possibility of adding one or more other features or components. In the drawings, the sizes of components may be exaggerated or reduced for convenience of explanation. For example, since the size and shape of each component shown in the drawings are arbitrarily shown for convenience of explanation, the disclosure is not necessarily limited to those illustrated.

As used herein, the terms “configured to” may be interchangeably used with the terms “suitable for,” “having the capacity to,” “designed to,” “adapted to,” “made to,” or “capable of” depending on circumstances. The term “configured to” does not essentially mean “specifically designed in hardware to.” Rather, the term “configured to” may mean that a device can perform an operation together with another device or parts. For example, a ‘device configured (or set) to perform A, B, and C’ may be a dedicated device to perform the corresponding operation or may mean a general-purpose device capable of various operations including the corresponding operation. Additionally, as used herein, a device that is ‘configured to perform A, B, and C,’ should be interpreted as both a device which directly performs A, B, and C, and a device which indirectly performs A, B, and C through a different device.

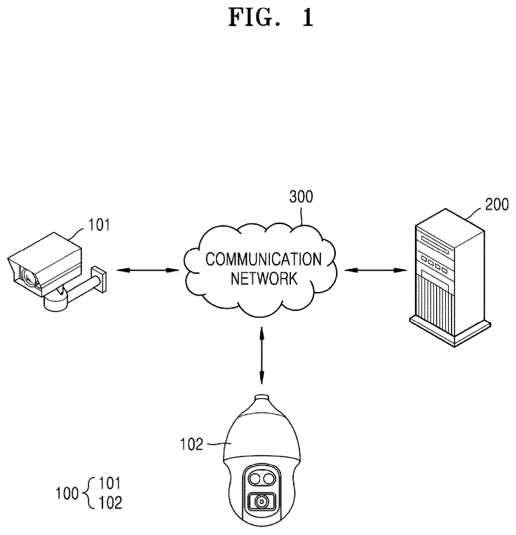

FIG. 1 is a diagram schematically illustrating a surveillance camera system according to an embodiment.

The surveillance camera system according to an embodiment may acquire a stabilized image even when the surveillance camera is finely shaken.

As shown in FIG. 1, the surveillance camera system according to an embodiment may include a surveillance camera 100 for acquiring images, an image storage device 200 for storing images, and a communication network 300 for interconnecting the surveillance camera 100 to the image storage device 200.

The surveillance camera 100 according to an embodiment may be a device that acquires an image of a surrounding environment. In an embodiment, the surveillance camera 100 may correct an image according to a series of processes for stabilizing the acquired image. A detailed description of a process of correcting an image by the surveillance camera 100 is provided below.

In the disclosure, “stabilization” of an image may mean reducing shaking or trembling of an image generated by unintended movement of the surveillance camera 100.

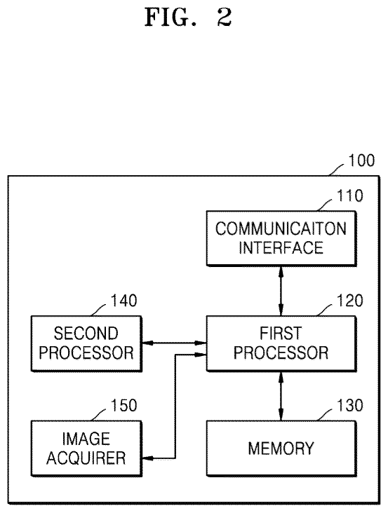

FIG. 2 is a diagram schematically showing a configuration of a surveillance camera 100 according to an embodiment.

Referring to FIG. 2, the surveillance camera 100 according to an embodiment may include a communication interface 110, a first processor 120, a memory 130, a second processor 140, and an image acquirer 150. At least one of the components, elements, modules or units represented by a block as illustrated in FIG. 2 may be embodied as various numbers of hardware, software and/or firmware structures that execute respective functions described above, according to an exemplary embodiment. For example, at least one of these components, elements, modules or units may use a direct circuit structure, such as a memory, processing, logic, a look-up table, etc. that may execute the respective functions through controls of one or more microprocessors or other control apparatuses. Also, at least one of these components, elements, modules or units may be specifically embodied by a module, a program, or a part of code, which contains one or more executable instructions for performing specified logic functions, and executed by one or more microprocessors or other control apparatuses. Also, at least one of these components, elements, modules or units may further include a processor such as a central processing unit (CPU) that performs the respective functions, a microprocessor, or the like. Two or more of these components, elements, modules or units may be combined into one single component, element, module or unit which performs all operations or functions of the combined two or more components, elements, modules or units. Also, at least part of functions of at least one of these components, elements, modules or units may be performed by another of these components, elements, modules or units. Further, although a bus is not illustrated in the above block diagrams, communication between the components, elements, modules or units may be performed through the bus. Functional aspects of the above exemplary embodiments may be implemented in algorithms that execute on one or more processors. Furthermore, the components, elements, modules or units represented by a block or processing steps may employ any number of related art techniques for electronics configuration, signal processing and/or control, data processing and the like.

The communication interface 110 may be a device including hardware and software for transmitting/receiving an image or the like to/from the surveillance camera 100 through a wired/wireless connection with another network device such as the image storage device 200. For example, the communication interface 110 may include any one or any combination of a digital modem, a radio frequency (RF) modem, an antenna circuit, a WiFi chip, and related software and/or firmware.

The first processor 120 may be a device that controls a series of processes of acquiring an image, stabilizing the acquired image, and transmitting the same to another network device such as the image storage device 200. The first processor 120 may refer to a data processing device embedded in hardware, having a physically structured circuit to perform a function expressed by, for example, code or commands in a program. As an example of a data processing device embedded in hardware, a processing device such as a microprocessor, a central processing unit (CPU), a processor core, a multiprocessor, an application-specific integrated circuit (ASIC), and a field programmable gate array (FPGA) may be included, but the scope of the disclosure is not limited thereto. The first processor 120 may be implemented by one processor or a plurality of processors.

The memory 130 may perform a function of temporarily or permanently storing data processed by the surveillance camera 100. The memory 130 may include magnetic storage media or flash storage media, but the scope of the disclosure is not limited thereto. For example, the memory 130 may temporarily and/or permanently store the acquired image. The memory 130 may include volatile memory such as a static random access memory (S-RAM) and a dynamic random access memory (D-RAM) for temporarily storing data. In addition, the memory 130 may include a non-volatile memory such as a read only memory (ROM), an erasable programmable read only memory (EPROM), and an electrically erasable programmable read only memory (EEPROM) for long-term storage of data. The memory 130 may be implemented by at least one of the aforementioned memory devices, but is not limited thereto.

The second processor 140 may refer to a device that performs an operation under the control of the first processor 120 described above. For example, the second processor 140 may perform an operation of extracting a feature point from an input frame or an operation of generating motion data of the input frame. However, this is only an example, and embodiments are not limited thereto.

The second processor 140 may be a device having higher computational power than the first processor 120 described above. For example, the second processor 140 may include a graphics processing unit (GPU) and/or a neural processing unit (NPU). However, this is only an example, and embodiments are not limited thereto. In an embodiment, the second processor 140 may be implemented as one processor or a plurality of processors.

The surveillance camera 100 according to an embodiment may not include the second processor 140. For example, in FIG. 1, the first surveillance camera 101 may be configured to include the second processor 140, and the second surveillance camera 102 may be configured to not include the second processor.

The image acquirer 150 may refer to various types of devices that convert an optical signal into an electrical signal. For example, the image acquisition unit 150 may be a device including a charge coupled device (CCD) or complementary metal oxide semiconductor (CMOS), which acquires ambient light and converts the same into an electrical signal, that is, a form of an image.

In the disclosure, the surveillance camera 100 may be referred to and described as an image processing device.

The image storage device 200 according to an embodiment may be a device that receives an image from the surveillance camera 100 and stores and/or transmits the received image. For example, the image storage device 200 may be any one of a Video Management System (VMS), a Central Management System (CMS), a Network Video Recorder (NVR), and a Digital Video Recorder (DVR) or a device included in any one of the VMS, CMS, NVR, and DVR.

In an embodiment, the image storage device 200 may stabilize and store images received from the surveillance camera 100. Here, as described above, “stabilization” of an image may mean reducing shaking or trembling of an image generated by unintended movement of the surveillance camera 100.

The communication network 300 according to an embodiment may include, for example, wired networks such as local area networks (LANs), wide area networks (WANs), metropolitan area networks (MANs), integrated service digital networks (ISDNs), or wireless networks such as wireless LANs, code-division multiple access (CDMA), Bluetooth, and satellite communication, but the scope of the disclosure is not limited thereto.

Hereinafter, description is made on the premise that the image stabilization method according to an embodiment is performed by the surveillance camera 100.

The first processor 120 according to an embodiment may acquire an input image. For example, the first processor 120 may acquire an image of the surrounding environment of the surveillance camera 100 as an input image through the image acquirer 150.

In the disclosure, the “input image” may include one or more frames as the surveillance camera 100 senses the surrounding environment. In the disclosure, an individual frame configuring such an input image may be referred to as an “input frame”.

In the disclosure, for convenience of description, “acquiring” an image and “correcting” an image according to a process to be described below are described separately, but embodiments are not limited thereto. Therefore, the image “correction” process described in the disclosure may be performed as part of the process of “acquiring”an image.

The first processor 120 according to an embodiment may determine the size of one or more unit areas based on the degree of noise of the input frame constituting the input image. According to an embodiment, “noise” of an input frame may represent a magnitude of a disturbance or variation in the input image data, which may arise from factors such as motion, vibrations, or environmental conditions that can affect the clarity or stability of the image.

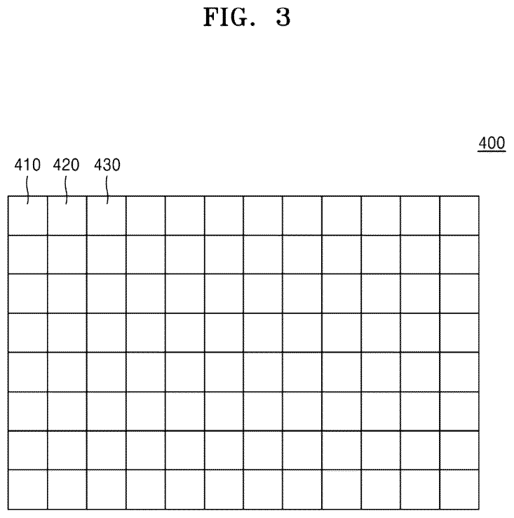

FIG. 3 is a diagram to describe unit areas according to an embodiment.

In the disclosure, the “unit area” may mean the size of a partial image used to determine the motion characteristics of an input frame 400. Therefore, as the unit area becomes large, the input frame 400 may be divided into a lesser number of areas to determine the motion characteristics, and as the unit area becomes small, the input frame 400 may be divided into a greater number of areas to determine the motion characteristics.

For example, the unit areas may include areas such as a first unit area 410, a second unit area 420, and a third unit area 430 that do not overlap each other as illustrated on the input frame 400 of FIG. 3. However, this is only an example, and embodiments are not limited thereto.

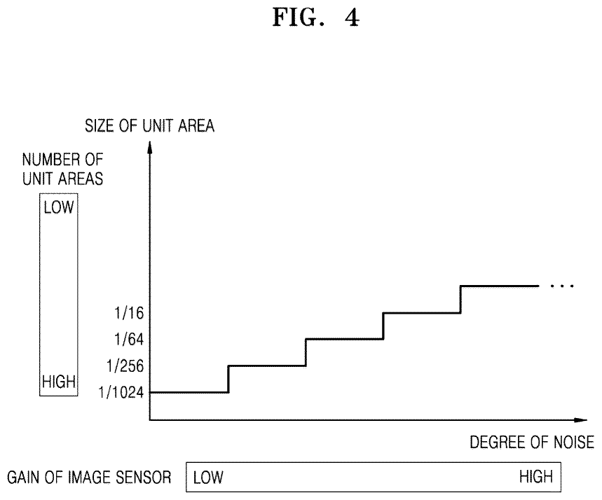

FIG. 4 is a diagram illustrating a method in which a first processor 120 determines the size of one or more unit areas.

As shown in FIG. 4, the first processor 120 according to an embodiment may decrease the number of one or more unit areas constituting the input frame by increasing the size of one or more unit areas to determine a more stable representative value as the noise level of the input frame increases.

On the contrary, the first processor 120 according to an embodiment may increase the number of one or more unit areas constituting the input frame by reducing the size of one or more unit areas as the noise level of the input frame decreases.

As described above, according to the disclosure, the accuracy of input image correction may be improved by dynamically adjusting the size and number of unit areas used to determine motion characteristics based on the degree of noise of an image. Additionally, the input image may be efficiently processed by adjusting to the characteristics of the input image.

The first processor 120 according to an embodiment may determine a representative value of each of one or more unit areas constituting the input frame.

In the disclosure, the “representative value” may mean a value representing the image characteristics of unit area. Such a representative value may be determined based on the values of pixels belonging to the unit area.

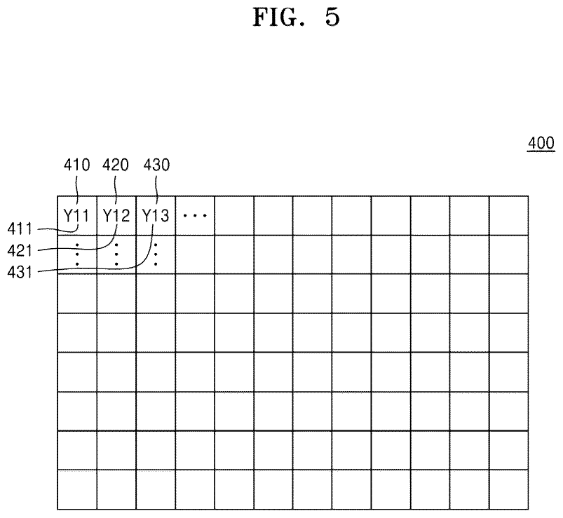

FIG. 5 is a diagram to explain a process in which the first processor 120 determines a representative value according to an embodiment.

As described above, the first processor 120 according to an embodiment may determine a representative value of each of one or more unit areas constituting the input frame. For example, the first processor 120 may determine a representative value 411 of the first unit area 410, a representative value 421 of the second unit area 420, and a representative value 431 of the third unit area 430.

In this case, the first processor 120 according to an embodiment may determine a representative value of a corresponding area based on values of pixels belonging to the partial area. For example, the first processor 120 may determine a representative value of a corresponding area based on an average of values of pixels belonging to the partial area.

In another embodiment, the first processor 120 may determine a representative value of a corresponding area according to various methods of determining representative values such as the most frequent value, maximum value, minimum value, and intermediate value. However, the listed representative value determination methods are only examples, and embodiments are not limited thereto.

The first processor 120 according to an embodiment may determine the type of each of the one or more unit areas based on at least one classification model and a representative value of each of the one or more unit areas. According to an embodiment, the at least one classification model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The classification model may alternatively or additionally include a software structure other than the hardware structure.

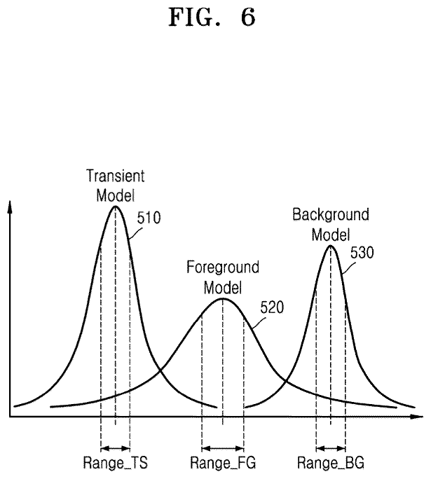

FIG. 6 is a graphical diagram to explain a classification model Hereinafter, for convenience of description, description is made on the premise that three classification models 510, 520, and 530 are used, and the respective ranges Range_TS, Range_FG, and Range_BG according to the three classification models 510, 520, and 530 are as shown. However, the disclosure is not limited thereto, and the disclosure may include more or less classification models with corresponding ranges.

In this description, the transient model 510 may be a short-term motion model that determines whether one or more unit areas belong to a temporary motion area with temporary movement, the foreground model 520 may be a foreground model that determines whether one or more unit areas belong to the foreground area, and the background model 530 may be a background model that determines whether one or more unit areas belong to the background area.

The first processor 120 according to an embodiment may determine the type of each of the one or more unit areas based on whether each representative value of the one or more unit areas falls within a range according to each of the at least one classification model.

In the disclosure, the “range” of the classification model may mean an interval of representative values to which the representative value of the corresponding sub-area belongs so that the sub-area can be classified into an area of a type according to each classification model.

For example, when the representative value of the first partial area falls within the range Range_BG according to the background model 530, the first processor 120 may determine the type of the first partial area as the “background”. Of course, the first processor 120 may determine the type of the first partial area as a “temporary motion area” when the representative value of the first partial area falls within the range Range_TS according to the transient model 510, and may determine the type of the first partial area as a “foreground” when the representative value of the first partial area falls within the range Range_FG according to the foreground model 520.

In an embodiment, the range according to each of the at least one classification model may be defined in the form of an average and a standard deviation. In other words, the range of the individual classification model may be defined as a section having a width corresponding to the standard deviation in both directions around the average value according to the corresponding model. In an embodiment, the range of the classification model may be defined as a lower limit and an upper limit.

The first processor 120 according to an embodiment may adjust a range according to each of the at least one classification model based on motion data of each of at least one frame constituting the input image.

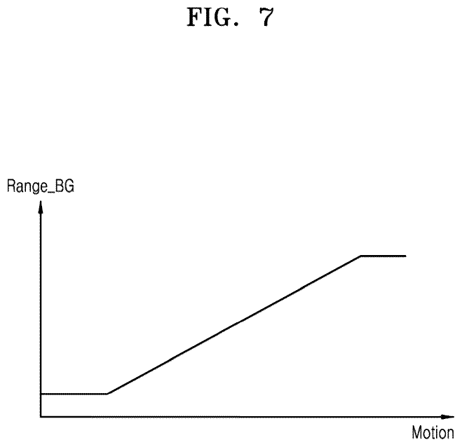

FIG. 7 is a graphical diagram to describe a process in which the first processor 120 adjusts a classification range according to the background model 530.

The first processor 120 according to an embodiment may generate reference motion data based on motion data of at least one previous frame constituting an input image. In addition, the first processor 120 may adjust the range according to the classification model 530, that is, the background model, by referring to the reference motion data.

In this case, the first processor 120 according to an embodiment may expand the range according to the background model 530 as the movement of the input image increases by referring to the reference motion data.

On the contrary, as the movement of the input image decreases, the first processor 120 may reduce the range according to the background model 530.

In addition, according to an embodiment, malfunction may be minimized by adjusting, based on the degree of motion of an input image, the range of a model used to classify unit areas into background types.

The first processor 120 according to an embodiment may extract at least one valid feature point in the input frame by referring to each type of one or more unit areas.

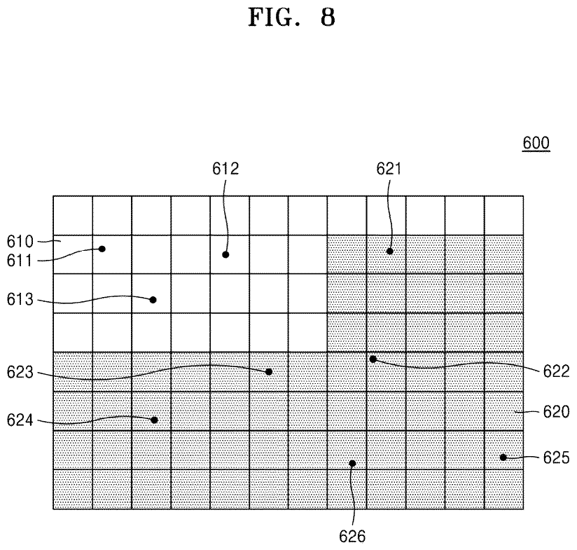

FIG. 8 is a diagram to explain a process of extracting at least one valid feature point in an input frame by the first processor 120 according to an embodiment.

Hereinafter, for convenience of description, the uncolored areas in the input frame 600 may be areas 610 having a type determined as a foreground area, colored areas may be areas 620 having a type determined as a background area, and points 611, 612, 613, 621, 622, 623, 624, 625, and 626 may be feature points of the input frame 600.

The first processor 120 according to an embodiment may determine, as candidate valid feature points, the feature points 621, 622, 623, 624, 625, and 626 belonging to the areas 620 having the type determined as the background area among one or more unit areas constituting the input frame 600.

Subsequently, the first processor 120 according to an embodiment may extract, as valid feature points, at least some of the candidate valid feature points extracted based on the contrast. For example, the first processor 120 may extract, as valid feature points, upper N feature points having high contrast among the candidate valid feature points.

Accordingly, the first processor 120 may not use, as the valid feature points, the feature points 611, 612, and 613 on the areas not determined as the background area.

The first processor 120 according to an embodiment may generate motion data of the input frame based on inter-frame motion data of at least one valid feature point.

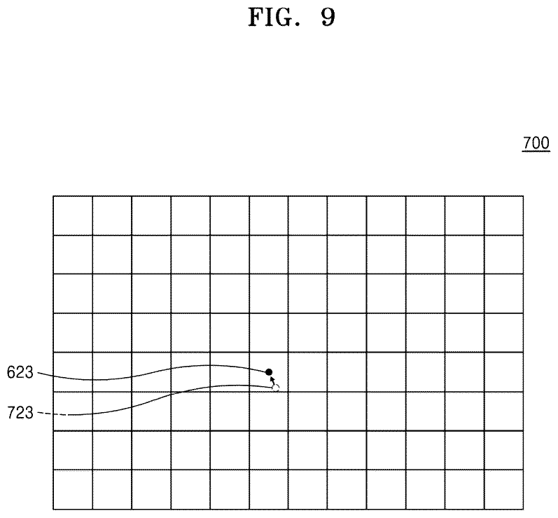

FIG. 9 is a diagram to describe a process in which the first processor 120 generates motion data according to an embodiment.

The first processor 120 according to an embodiment may generate motion data of an input frame 700 based on a difference between a position in the frame preceding the input frame 700 and a position in the input frame 700, with respect to at least one valid feature point belonging to the background area of the input frame 700.

For example, the first processor 120 may generate motion data LMV of the input frame 700 based on a difference between a position of a feature point 623 in the input frame 700 and a position of a corresponding feature point 723 in a frame immediately preceding the input frame 700. However, this is only an example, and embodiments are not limited thereto.

The first processor 120 according to an embodiment may correct the input frame based on motion data of the input frame. For example, the first processor 120 may estimate the motion of the input frame by calculating global motion data GMV using local motion data LMV, which is motion data for feature points, and then correct the input frame by moving the input frame of the same size as the motion of the input frame in the opposite direction.

Accordingly, the shaking of the input image may be accurately corrected, even when a large dynamic object appears.

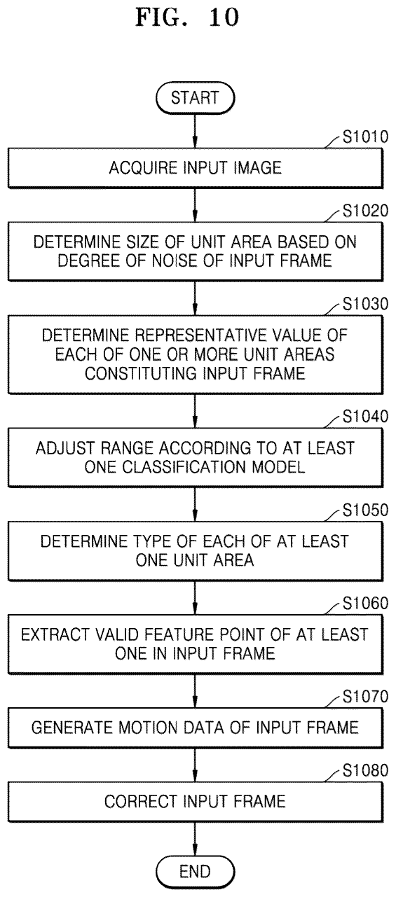

FIG. 10 is a flowchart illustrating an image stabilization method performed by the surveillance camera 100 according to an embodiment. Hereinafter, description is made with reference to FIG. 10 together with FIGS. 1 to 9.

The first processor 120 according to an embodiment may acquire an input image (S1010). For example, the first processor 120 may acquire an image of the surrounding environment of the surveillance camera 100 as an input image through the image acquisition unit 150.

The first processor 120 according to an embodiment may determine the size of one or more unit areas based on the degree of noise of the input frame constituting the input image (S1020).

As shown in FIG. 4, the first processor 120 according to an embodiment may decrease the number of one or more unit areas constituting the input frame by increasing the size of one or more unit areas to determine a more stable representative value as the noise level of the input frame increases.

On the contrary, the first processor 120 according to an embodiment may increase the number of one or more unit areas constituting the input frame by reducing the size of one or more unit areas as the noise level of the input frame decreases.

The first processor 120 according to an embodiment may determine a representative value of each of one or more unit areas constituting the input frame (S1030).

FIG. 5 is a diagram to explain a process in which the first processor 120 determines a representative value according to an embodiment.

As described above, the first processor 120 according to an embodiment may determine a representative value of each of one or more unit areas constituting the input frame. For example, the first processor 120 may determine a representative value 411 of the first unit area 410, a representative value 421 of the second unit area 420, and a representative value 431 of the third unit area 430.

In this case, the first processor 120 according to an embodiment may determine a representative value of a corresponding area based on values of pixels belonging to the partial area. For example, the first processor 120 may determine a representative value of a corresponding area based on an average of values of pixels belonging to the partial area.

In an embodiment, the first processor 120 may determine a representative value of a corresponding area according to various methods of determining representative values such as the most frequent value, maximum value, minimum value, and intermediate value. However, the listed representative value determination methods are only examples, and embodiments are not limited thereto.

The first processor 120 according to an embodiment may adjust a range according to each of the at least one classification model based on motion data of each of the at least one frame constituting the input image (S1040).

The first processor 120 according to an embodiment may generate reference motion data based on motion data of at least one frame constituting an input image. In addition, the first processor 120 may adjust the range according to the classification model 530, that is, the background model, by referring to the reference motion data.

In this case, the first processor 120 according to an embodiment may expand the range according to the background model 530 as the movement of the input image increases by referring to the reference motion data.

On the contrary, as the movement of the input image decreases, the first processor 120 may reduce the range according to the background model 530.

The first processor 120 according to an embodiment may determine the type of each of the one or more unit areas based on at least one classification model and a representative value of each of the one or more unit areas (S1050).

FIG. 6 is a graphical diagram to explain a classification model.

For example, three classification models 510, 520, and 530 may be used, and respective ranges Range_TS, Range_FG, and Range_BG may correspond to the three classification models 510, 520, and 530 as shown.

For example, a transient model 510 may be a short-term motion model that based on whether one or more unit areas belong to a temporary motion area with temporary movement, the foreground model 520 may be a foreground model that based on whether one or more unit areas belong to the foreground area, and the background model 530 may be a background model that based on whether one or more unit areas belong to the background area.

The first processor 120 according to an embodiment may determine the type of each of the one or more unit areas based on whether each representative value of the one or more unit areas falls within a range according to each of the at least one classification model. For example, when the representative value of the first partial area falls within the range Range_BG according to the background model 530, the first processor 120 may determine the type of the first partial area as the “background”. The first processor 120 may determine the type of the first partial area as a “temporary motion area” when the representative value of the first partial area falls within the range Range_TS according to the transient model 510, and may determine the type of the first partial area as a “foreground” when the representative value of the first partial area falls within the range Range_FG according to the foreground model 520.

In an embodiment, the range according to each of the at least one classification model may be defined in the form of an average and a standard deviation. In other words, the range of the individual classification model may be defined as a section having a width corresponding to the standard deviation in both directions around the average value according to the corresponding model. In another embodiment, the range of the classification model may be defined as a lower limit and an upper limit.

The first processor 120 according to an embodiment may extract at least one valid feature point in the input frame by referring to each type of one or more unit areas (S1060).

Referring to FIG. 8, first processor 120 according to an embodiment may determine, as candidate valid feature points, the feature points 621, 622, 623, 624, 625, and 626 belonging to the areas 620 having the type determined as the background area among one or more unit areas constituting the input frame 600.

Subsequently, the first processor 120 according to an embodiment may extract, as valid feature points, at least some of the candidate valid feature points extracted based on the contrast. For example, the first processor 120 may extract, as valid feature points, upper N feature points having high contrast among the candidate valid feature points. For example, the first processor 120 may extract, as valid feature points, one or more of the features points 621, 622, 623, 624, 625, and 626 determined as the candidate valid feature points, based on the contrast.

Accordingly, the first processor 120 may not use, as the valid feature points, the feature points 611, 612, and 613 on the areas not determined as the background area.

The first processor 120 according to an embodiment may generate motion data of the input frame based on inter-frame motion data of at least one valid feature point (S1070).

The first processor 120 according to an embodiment may generate motion data of the input frame 700 based on a difference between a position in the frame preceding the input frame 700 and a position in the input frame 700, with respect to at least one valid feature point belonging to the background area of the input frame 700.

For example, the first processor 120 may generate the motion data of the input frame 700 based on a difference between a position of a feature point 623 in the input frame 700 and a position of a corresponding feature point 723 in a frame immediately preceding the input frame 700. However, this is only an example, and embodiments are not limited thereto.

The first processor 120 according to an embodiment may correct the input frame based on motion data of the input frame (S1080). For example, the first processor 120 may estimate the motion of the input frame by determining global motion data GMV using local motion data LMV, which is motion data for feature points, and then correct the input frame by moving the input frame of the same size as the motion of the input frame in the opposite direction.

Accordingly, the shaking of the input image may be accurately corrected, even when a large dynamic object appears.

As described above, for convenience of description, description has been made on the premise that the image stabilization method according to an embodiment is performed by the surveillance camera 100, but embodiments are not limited thereto. Therefore, the image stabilization method according to an embodiment may be performed in various types of image processing devices such as the image storage device 200.

The embodiments described above may be implemented in the form of a computer program executable through various components on a computer, and such a computer program may be recorded on computer-readable media. In this case, the computer-readable media may include magnetic media such as hard disks, floppy disks and magnetic tapes, optical recording media such as computer disc read only memories (CD-ROMs) and digital versatile discs (DVDs), magnetic-optical media such as floptical disks, and hardware devices specifically configured to store and execute program instructions such as read only memory (ROM), random access memory (RAM), and flash memory. Furthermore, a medium may include an intangible medium implemented in a form that can be transmitted on a network, for example, a medium that can be implemented in the form of software or applications and transmitted and distributed over the network.

The computer program may be specially designed and configured for the disclosure or may be known to and usable by those skilled in the art in computer software.

Examples of computer programs may include not only machine language code, such as those made by a compiler, but also advanced language code that may be executed by a computer using an interpreter or the like.

The specific implementations described in the disclosure are embodiments and do not limit the scope of the disclosure in any way. For simplicity of the disclosure, descriptions of conventional electronic configurations, control systems, software, and other functional aspects of the systems may be omitted. In addition, the connections of the lines or connecting members between the components shown in the drawing illustrate functional connections and/or physical or circuit connections, and may be represented as a variety of alternative or additional functional connections, physical connections, or circuit connections in real devices. In addition, if a component has no specific mention, such as “essential” and “important,” the component may not be an essential component for the application of the inventive concept.

Therefore, the inventive concept should not be limited to the embodiments described above, and not only the claims described below but also all scope changed equivalent to or equivalent to the claims will fall within the scope of the disclosure.

According to the disclosure, even when a large dynamic object of an image appears, robust correction may be performed against the shaking of the input image.

In addition, the accuracy of input image correction may be improved by dynamically adjusting the size of unit areas used and the number of unit areas used in determining the motion characteristics of an input image.

In addition, malfunction may be minimized by adjusting, based on the degree of motion of an input image, the range of a model used to classify unit areas into background types.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An image stabilization method comprising:
determining a representative value of one or more unit areas constituting an input frame;
determining a type of the one or more unit areas based on at least one classification model and the representative value of each of the one or more unit areas, respectively;
extracting at least one valid feature point within the input frame based on the type of the one or more unit areas;
generating motion data of the input frame based on an inter-frame motion of the at least one valid feature point; and
correcting the input frame based on the motion data of the input frame.

2. The image stabilization method of claim 1, further comprising determining a size of the one or more unit areas based on a noise level of the input frame before determining the representative value of the one or more unit areas.

3. The image stabilization method of claim 2, wherein the determining the size of the one or more unit areas comprises:
based on an increase in the noise level of the input frame, increasing the size of the one or more unit areas to reduce a quantity of the one or more unit areas constituting the input frame, and
based on a decrease in the noise level of the input frame, decreasing the size of the one or more unit areas to increase the quantity of the one or more unit areas constituting the input frame.

4. The image stabilization method of claim 1, wherein the determining the type of the one or more unit areas comprises determining the type based on whether a representative value of the one or more unit areas is within a range according to the at least one classification model.

5. The image stabilization method of claim 4, further comprising adjusting the range according to the at least one classification model based on the motion data of the input frame.

6. The image stabilization method of claim 5, wherein the at least one classification model comprises a background model to determine whether one or more unit areas correspond to a background area, and
wherein the adjusting of the range comprises:
generating reference motion data based on the motion data of the input frame, and
adjusting the range according to the background model based on the reference motion data.

7. The image stabilization method of claim 6, wherein the adjusting the range comprises:
expanding the range of the background model based on an increase in movement of the input frame based on the reference motion data; and
reducing the range of the background model based on a decrease in the movement of the input frame based on the reference motion data.

8. The image stabilization method of claim 4, wherein the at least one classification model comprises:
a background model to determine whether one or more unit areas correspond to a background area;
a foreground model to determine whether one or more unit areas correspond to a foreground area; and
a motion model to determine whether one or more unit areas correspond to a motion area that has motion.

9. The image stabilization method of claim 1, wherein the extracting the valid feature point comprises:
determining, as candidate valid feature points, feature points corresponding to an area determined as a background area among the one or more unit areas constituting the input frame; and
extracting at least some of the candidate valid feature points based on a contrast of the valid feature point.

10. The image stabilization method of claim 1, wherein the generating the motion data of the input frame comprises generating motion data based on a difference between a position in a frame preceding the input frame and a position in the input frame, with respect to at least one valid feature point corresponding to a background area of the input frame.

11. An image processing device comprising at least one memory storing instructions, and at least one processor configured to execute the instructions, wherein, by executing the instructions, the at least one processor is configured to:
determine a representative value of one or more unit areas constituting an input frame;
determine a type of the one or more unit areas based on at least one classification model and the representative value of the one or more unit areas, respectively;
extract at least one valid feature point within the input frame based on the type of the one or more unit areas;
generate motion data of the input frame based on an inter-frame motion of the at least one valid feature point; and
correct the input frame based on the motion data of the input frame.

12. The image processing device of claim 11, wherein the at least one processor is further configured to determine a size of the one or more unit areas based on a noise level of the input frame.

13. The image processing device of claim 12, wherein the at least one processor is further configured to:
based on an increase in the noise level of the input frame, increase the size of the one or more unit areas to reduce a quantity of the one or more unit areas constituting the input frame, and
based on a decrease in the noise level of the input frame, decrease the size of the one or more unit areas to increase the quantity of the one or more unit areas constituting the input frame.

14. The image processing device of claim 11, wherein the at least one processor is further configured to determine the type of the one or more unit areas based on whether a representative value of the one or more unit areas is within a range according to the at least one classification model.

15. The image processing device of claim 14, wherein the at least one processor is further configured to adjust the range of the at least one classification model based on the motion data of the input frame.

16. The image processing device of claim 15, wherein the at least one classification model comprises a background model configured to determine whether one or more unit areas correspond to a background area, and
wherein the at least one processor is further configured to:
generate reference motion data based on the motion data of the input frame, and
adjust the range according to the background model based on the reference motion data.

17. The image processing device of claim 14, wherein the at least one classification model comprises:
a background model configured to determine whether one or more unit areas correspond to a background area;
a foreground model configured to determine whether one or more unit areas correspond to a foreground area; and
a motion model configured to determine whether one or more unit areas correspond to a motion area that has motion.

18. The image processing device of claim 11, wherein the at least one processor is further configured to:
determine, as candidate valid feature points, feature points corresponding to an area determined as a background area among the one or more unit areas constituting the input frame; and
extract at least some of the candidate valid feature points based on a contrast of the valid feature point.

19. The image processing device of claim 11, wherein the at least one processor is further configured to generate motion data of the input frame based on a difference between a position in a frame preceding the input frame and a position in the input frame, with respect to at least one valid feature point corresponding to a background area of the input frame.

20. A non-transitory recording medium storing a computer program, which, when executed, causes at least one processor to execute a method comprising:
determining a representative value of a unit area included in an input frame;
determining a type of the unit area based on at least one classification model and the representative value of the unit area;
extracting at least one valid feature point within the input frame based on the type of the unit area;
generating motion data of the input frame based on an inter-frame motion of the at least one valid feature point; and
correcting the input frame based on the motion data of the input frame.
